(19) United States
(12) Patent Application Publication
(10) Pub. No.: US 2004/0122624 A1
(43) Pub. Date: Jun. 24, 2004

(54) Semiconductor wafer inspecting method

(75) Inventor: Hideki Naruoka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/625,532

(22) Filed: Jul. 24, 2003

(30) Foreign Application Priority Data
Oct. 7, 2002 (JP) 2002-293613

(51) Int. Cl. G06F 11/30

(52) U.S. Cl. 702/185

(57) ABSTRACT

It is an object to obtain a method of inspecting a semiconductor wafer which can carry out an inspection accurately. At a step S11, a virtual divided wafer is generated based on dividing cell size data and dividing cell arrangement data which define a dividing condition. At a step S12, an inspection result information database is checked over the virtual divided wafer to calculate a nonstandard cell number (C0) having a nonstandard portion and a standard cell number (C1) having no nonstandard portion, respectively. At a step S13, a usable area rate PUA (%) (=(C1/C10)* 100) is calculated based on a total virtual dividing unit cell number (C10) and the standard cell number (C1).

### BACKGROUND OF THE INVENTION

1. Field of the Invention

The present invention relates to a method of inspecting a semiconductor wafer to inspect quality of a semiconductor wafer based on a defect generated on a semiconductor substrate such as the semiconductor wafer, or the like.

2. Description of the Background Art

A semiconductor device is formed on a disk-shaped semiconductor substrate referred to as a semiconductor wafer. A variation in quality in a surface, for example, a dust on the semiconductor wafer, a defect of the semiconductor wafer, a thickness of a film or a resistance has a bad influence on a characteristic of the semiconductor device to be formed and a yield is deteriorated. For this reason, a shipping standard of the semiconductor wafer is very strict and whether the standard is satisfied over a whole surface of the semiconductor wafer is decided by an inspection. Thus, only an acceptable product is shipped.

However, when a quality level required for the semiconductor wafer is enhanced with microfabrication of the device, a large number of rejected products are generated. Furthermore, a diameter of the semiconductor wafer is increased and an area to guarantee the quality is also increased. Therefore, a rejection rate is further increased so that a cost of the semiconductor wafer is increased, and furthermore, there is much waste in respect of an environment and energy saving.

A conventional method of deciding the quality of the semiconductor wafer has been disclosed in a patent document 1 (Japanese Patent Application Laid-Open No. 11-126736), for example. In this method, the number of defects present on a semiconductor wafer is detected to be the number of defects and is detected to be the number of chips having the defects, and the number of defects and the number of chips are compared with the number of reference defective chips and the number of reference defects which are preset. Thus, the quality of the semiconductor wafer is decided. In some cases, virtual chips are set to be a plurality of chips.

Conventionally, the quality of the semiconductor wafer has been decided as described above. There is a marked tendency to carry out an inspection under too strict conditions. Originally, a normal semiconductor wafer is decided to be defective. Therefore, there is a problem in that the semiconductor wafer cannot be utilized effectively.

### SUMMARY OF THE INVENTION

It is an object of the present invention to provide a method of inspecting a semiconductor wafer which can carry out an inspection more accurately.

The present invention is directed to a method of inspecting a semiconductor wafer including the following steps (a) to (d). The step (a) carries out an inspection including a predetermined inspection object item for a semiconductor wafer, thereby obtaining inspection information by which a position on the semiconductor wafer of a nonstandard portion satisfying no inspection standard can be recognized. The step (b) virtually divides a virtual wafer corresponding to the semiconductor wafer under a predetermined dividing condition, thereby generating a virtual divided wafer having a plurality of virtual dividing unit cells arranged virtually. The step (c) checks the inspection information over the virtual divided wafer, thereby obtaining the number of standard cells which do not include the nonstandard portion in the virtual dividing unit cells. The step (d) calculates a usable cell rate to be a ratio of the number of the standard cells to the total number of the virtual dividing unit cells.

The method of inspecting a semiconductor wafer according to the present invention can carry out a quality inspection with high precision in consideration of the position on the semiconductor wafer in which the nonstandard portion is generated based on the usable cell rate related to the number of the standard cells. In addition, it is also possible to maintain high precision in the quality decision although a size of the semiconductor wafer, the total number of the virtual dividing unit cells and the like are changed, because the usable cell rate is the ratio of the number of the standard cells to the total number of the virtual dividing unit cells.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an explanatory diagram typically showing a processing procedure for a method of inspecting a semiconductor wafer according to a first embodiment of the present invention together with a flow of data,

FIG. 2 is an explanatory diagram showing a situation of a nonstandard portion of the semiconductor wafer after execution of an inspection,

FIG. 3 is an explanatory diagram showing an example of a virtual divided wafer,

FIG. 4 is an explanatory diagram showing contents of calculation of the number of nonstandard portion containing virtual dividing cells,

FIG. 5 is an explanatory diagram typically showing a processing procedure for a method of inspecting a semiconductor wafer according to a second embodiment of the present invention together with a flow of data,

FIGS. 6 to 8 are explanatory diagrams showing an example of a virtual divided wafer,

FIG. 9 is a typical diagram showing a situation of a defect of the inspected semiconductor wafer in the form of a wafer map,

FIGS. 10 and 11 are typical diagrams showing the situation of the defect of the inspected semiconductor wafer,

FIG. 12 is a typical diagram showing contents of calculation of the number of nonstandard portion containing virtual dividing cells for a class A,

FIG. 13 is a typical diagram showing contents of calculation of the number of nonstandard portion containing virtual dividing cells for a class B,

FIG. 14 is a typical diagram showing contents of calculation of the number of nonstandard portion containing virtual dividing cells for a class C,

FIG. 15 is a typical diagram showing the contents of calculation of the number of nonstandard portion containing virtual dividing cells for the class A,

FIG. 16 is a typical diagram showing the contents of calculation of the number of nonstandard portion containing virtual dividing cells for the class B,

FIG. 17 is a typical diagram showing the contents of calculation of the number of nonstandard portion containing virtual dividing cells for the class C,

FIG. 18 is an explanatory diagram listing, in the form of a table, inspection object items according to third to seventh embodiments,

FIG. 19 is an explanatory diagram showing a part of processing contents of an inspecting method according to an eighth embodiment of the present invention,

FIGS. 20 to 22 are explanatory views showing a memory cell area and a peripheral area in a memory device,

FIG. 23 is an explanatory diagram typically showing a processing procedure for a method of inspecting a semiconductor wafer according to a ninth embodiment of the present invention together with a flow of data, and

FIG. 24 is a flow chart showing a method of determining a purchase price of a semiconductor wafer according to a tenth embodiment of the present invention.

### DESCRIPTION OF THE PREFERRED EMBODIMENTS

### First Embodiment

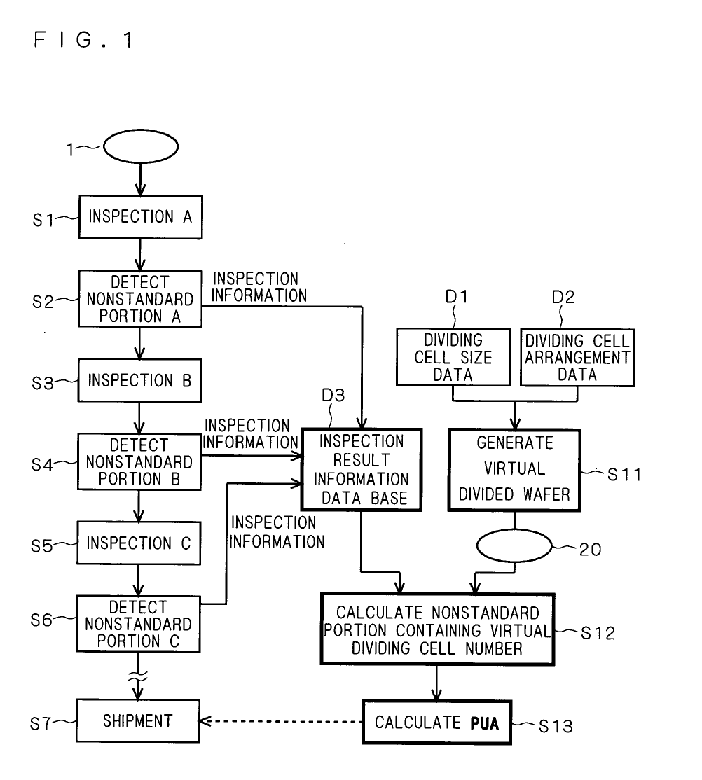

FIG. 1 is an explanatory diagram typically showing a processing procedure for a method of inspecting a semiconductor wafer according to a first embodiment of the present invention together with a flow of data.

With reference to FIG. 1, an inspection based on an inspection A is carried out for a semiconductor wafer 1 at a step S1. The inspection A is carried out for a predetermined inspection object item (object quality item).

At a step S2, subsequently, whether a standard is satisfied is decided based on a result of the inspection A. A portion which does not satisfy the inspection standard is detected to be a nonstandard portion A. Then, inspection information about the nonstandard portion A (an inspecting step, coordinates (indicative of a position on the semiconductor wafer 1), a size, an image, a contained impurity or the like) is given to an inspection result information database D3 and is thus stored therein.

At steps S3 and S4, then, an inspection B having different inspection object items from those of the inspection A is executed and inspection information about a nonstandard portion B is stored in the inspection result information database D3 in the same manner as the inspection A shown in the steps S1 and S2.

At steps S5 and S6, furthermore, an inspection C having different inspection object items from those of the inspections A and B is executed and inspection information about a nonstandard portion C is stored in the inspection result information database D3 in the same manner as the inspection A shown in the steps S1 and S2.

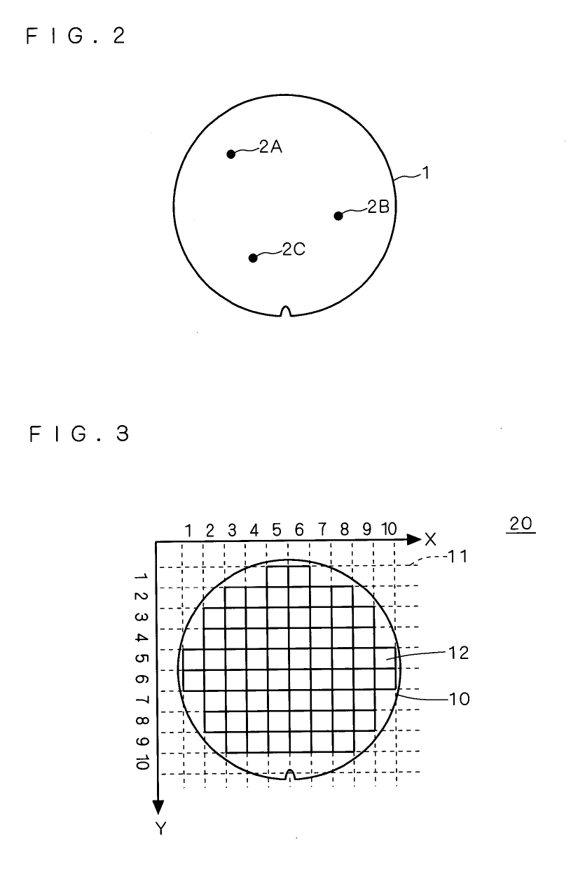

FIG. 2 is an explanatory diagram showing a situation (map) of a nonstandard portion of a semiconductor wafer based on the data stored in the inspection result information database D3 after the execution of the steps S1 to S6. As shown in FIG. 2, defects 2A, 2B and 2C to be the nonstandard portions A, B and C are indicated on the semiconductor wafer 1. By reconstructing inspection information about the nonstandard portions A to C stored in the inspection result information database D3, thus, it is possible to obtain integrated information indicative of any nonstandard portion which is present in any position of the semiconductor wafer 1. More specifically, the inspection result information database D3 can carry out a quality decision with high precision.

Returning to FIG. 1, at a step S11, a virtual divided wafer 20 is generated by virtually dividing a virtual wafer corresponding to the semiconductor wafer through a plurality of virtual dividing unit cells having a predetermined size and shape based on dividing cell size data D1 for defining a cell size and shape of the virtual dividing unit cell and the like and dividing cell arrangement data D2 for defining an arrangement of the virtual dividing unit cell on the semiconductor wafer 1 and the like. More specifically, at the step S11, the virtual divided wafer 20 is generated based on the dividing cell size data D1 and the dividing cell arrangement data D2 which define dividing conditions.

FIG. 3 is an explanatory diagram showing an example of the virtual divided wafer. As shown in FIG. 3, a virtual wafer 10 is provided and is divided into rectangular cells by a virtual dividing line 11, and any of the dividing cells which has a whole area present on the virtual wafer 10 is set to be a virtual dividing unit cell 12. In this case, the virtual dividing unit cell 12 may have a partial area present on the virtual wafer 10.

In the example of FIG. 3, the total number of the virtual dividing unit cells 12 having the whole areas present on the virtual wafer is 66 and the total number of the virtual dividing unit cells having partial areas present on the virtual wafer is 112.

As shown in FIG. 3, virtual coordinate axes of X and Y are provided so that coordinates of each virtual dividing unit cell can also be represented. In the present embodiment, the following description will be given by setting the cell having the whole area present on the virtual wafer 10 to be the virtual dividing unit cell 12 as shown in a solid line of FIG. 3.

Returning to FIG. 1, at a step S12, the inspection result information database D3 is checked over the virtual divided wafer 20 to calculate a nonstandard portion containing virtual dividing cell number C0.

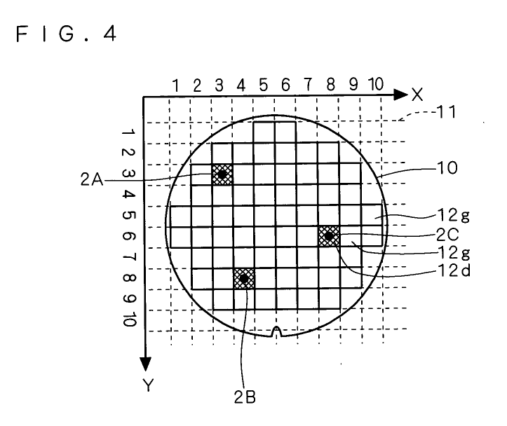

FIG. 4 is an explanatory diagram showing contents of the calculation of the nonstandard portion containing virtual dividing cell number (which will be hereinafter referred to as a “nonstandard cell” in some cases). As shown in FIG. 4, a defect regarded as the nonstandard portion on the semiconductor wafer 1 is caused to correspond onto the virtual divided wafer 20 without a shift. As a result, the virtual dividing unit cell 12 including any of the defects 2A to 2C is determined to be a nonstandard cell 12d and the number of the nonstandard cells 12d is set to be the nonstandard cell number C0. On the other hand, the virtual dividing unit cell 12 which does not include any of the defects 2A to 2C is determined to be a standard cell 12g and the number of the standard cells 12g is set to be a standard cell number C1.

Returning to FIG. 1, a usable area rate PUA (Percent Usable Area) is calculated at a step S13. More specifically, the usable area rate PUA (%) (=(C1/C10)* 100) is calculated by a total virtual dividing unit cell number C10 and the standard cell number C1. By the usable area rate PUA, a rate of the virtual dividing unit cell 12 (a usable cell rate) satisfying a standard in all the virtual dividing unit cells can be recognized to be a numeric value.

For instance, in the example of FIG. 4, the total virtual dividing unit cell number C10 is 66, the standard cell number C1 is 63, the nonstandard cell number C0 is 3 and the usable area rate PUA is 94.45% (rounded to two decimal places).

In the present embodiment, the usable area rate PUA is determined on a virtual dividing unit cell 12 unit. Therefore, it is possible to carry out a quality decision with higher precision than that in the case in which the quality is simply decided based on the number of defects.

For example, in the case in which “the number of defects is two or less” is set to be a standard, a product having three defects or more is always set to be nonstandard and is treated as a defective product. More specifically, a position in which the defect is generated is not taken into consideration at all.

In the present embodiment, however, the usable area rate PUA has different values in the case in which the defect is scattered over the semiconductor wafer and the case in which the defect concentrates in one virtual dividing unit cell 12 and a result of quality considering a position of the nonstandard portion in which the defect is generated (“even if three defects or more are generated, the number of the defects may be substantially regarded to be two or less” or the like) can be obtained as a numeric value. More specifically, a semiconductor wafer to be originally treated as an excellent product can be reliably decided to be the excellent product.

By using the usable area rate PUA setting the virtual dividing unit cell 12 corresponding to a size of a semiconductor product or the like to be a quality standard object unit, thus, it is possible to enhance precision in a quality decision. As a result, it is possible to effectively utilize the semiconductor wafer.

In addition, the usable area rate PUA is a rate of the standard cell number C1 to the total virtual dividing unit cell number C10. Therefore, the precision can be prevented from being changed by a variation in the size of the semiconductor wafer, the total virtual dividing unit cell number C10 and the like and the same precision in the quality decision can be maintained.

Returning to FIG. 1, at a step S7, the quality is decided based on the usable area rate PUA obtained at the step S13 and a final shipment is thus decided. In this case, it is possible to set a price taking the influence of a nonstandard portion of a real device into account by setting the price based on the usable area rate PUA.

### Second Embodiment

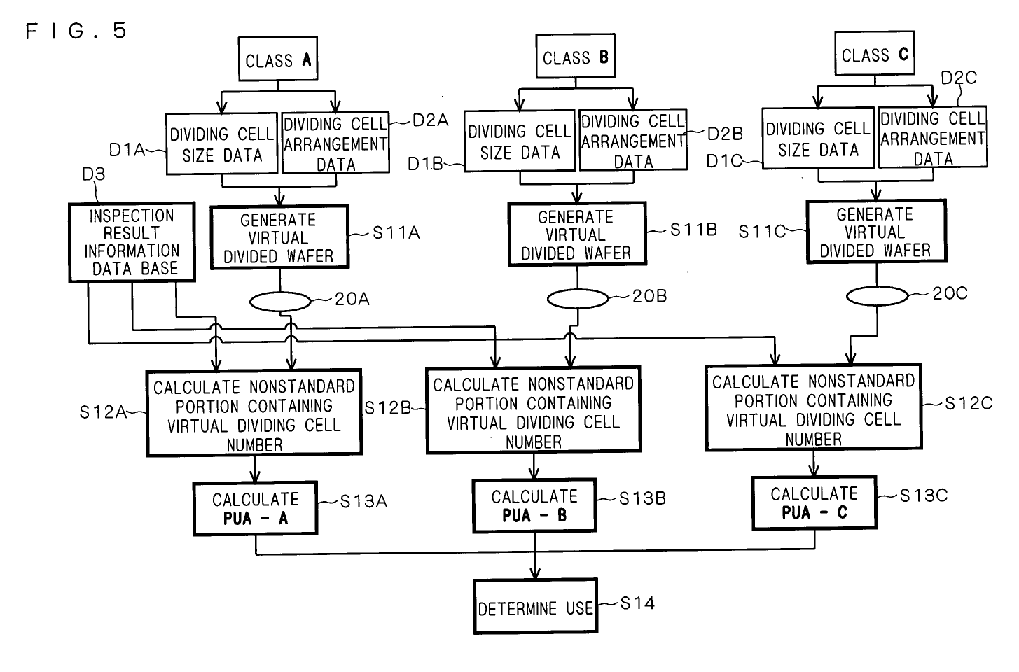

FIG. 5 is an explanatory diagram typically showing a processing procedure for a method of inspecting a semiconductor wafer according to a second embodiment of the present invention together with a flow of data. Since processings of steps S1 to S7 are basically the same as those of the first embodiment shown in FIG. 1, they are not illustrated in FIG. 5. With reference to FIG. 5, the processing procedure according to the second embodiment will be described below.

At a step S11A, a virtual divided wafer 20A is generated by virtually dividing a virtual wafer corresponding to the semiconductor wafer through a cell having a predetermined size and shape (a virtual dividing unit cell 12A) based on dividing cell size data D1A and dividing cell arrangement data D2A of a class A in the same manner as in the step S11 of FIG. 1.

At a step S11B, a virtual divided wafer 20B is generated by virtually dividing a virtual wafer corresponding to the semiconductor wafer through a cell having a predetermined size and shape (a virtual dividing unit cell 12B) based on dividing cell size data D1B and dividing cell arrangement data D2B of a class B in the same manner as in the step S11A.

At a step S11C, a virtual divided wafer 20C is generated by virtually dividing a virtual wafer corresponding to the semiconductor wafer through a cell having a predetermined size and shape (a virtual dividing unit cell 12C) based on dividing cell size data D1C and dividing cell arrangement data D2C of a class C in the same manner as in the step S11A.

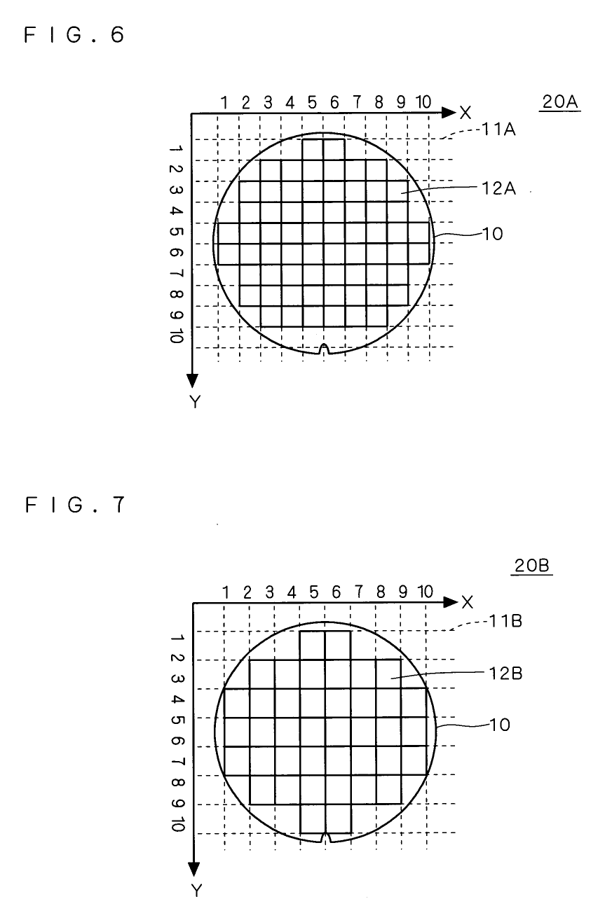

FIG. 6 is an explanatory diagram showing the virtual divided wafer 20A of the class A. As shown in FIG. 6, the virtual divided wafer 20A is obtained by dividing a virtual wafer 10 into a virtual dividing unit cell 12A based on a virtual dividing line 11A. The total number (=66) of the virtual dividing unit cells 12A is set to be a total virtual dividing unit cell number C10A.

FIG. 7 is an explanatory diagram showing the virtual divided wafer 20B of the class B. As shown in FIG. 7, the virtual divided wafer 20B is obtained by dividing the virtual wafer 10 into a virtual dividing unit cell 12B based on a virtual dividing line 11B. The total number (=40) of the virtual dividing unit cells 12B is set to be a total virtual dividing unit cell number C10B.

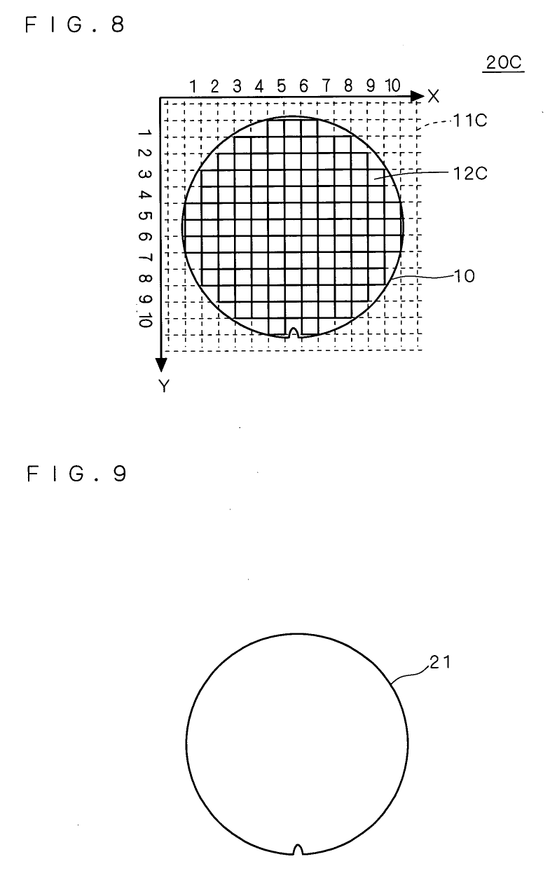

FIG. 8 is an explanatory diagram showing the virtual divided wafer 20C of the class C. As shown in FIG. 8, the virtual divided wafer 20C is obtained by dividing the virtual wafer 10 into a virtual dividing unit cell 12C based on a virtual dividing line 11C. The total number (=120) of the virtual dividing unit cells 12C is set to be a total virtual dividing unit cell number C10C. A cell size between the virtual dividing unit cells 12A to 12C is set to be increased in order of the classes C, A and B.

Returning to FIG. 5, at a step S12A, an inspection result information database D3 is checked over the virtual divided wafer 20A to calculate a nonstandard cell number C0A and a standard cell number C1A in the same manner as in the step S12 of FIG. 1.

At a step S12B, similarly, the inspection result information database D3 is checked over the virtual divided wafer 20B to calculate a nonstandard cell number C0B and a standard cell number C1B.

At a step S12C, similarly, the inspection result information database D3 is checked over the virtual divided wafer 20C to calculate a nonstandard cell number C0C and a standard cell number C1C.

Subsequently to the step S12A, at a step S13A, a usable area rate PUA-A (%) (=(C1A/C10A)* 100) is calculated by the total virtual dividing unit cell number C10A and the standard cell number C1A.

At a step S13B, similarly, a usable area rate PUA-B (%) (=(C1B/C10B)* 100) is calculated by the total virtual dividing unit cell number C10B and the standard cell number C1B.

At a step S13C, similarly, a usable area rate PUA-C (%) (=(C1C/C10C)* 100) is calculated by the total virtual dividing unit cell number C10C and the standard cell number C1C.

At a step S14, then, a use of the semiconductor wafer is determined based on the usable area rates PUA-A to C. The contents of the processing in the step S14 will be described below by giving an example.

FIGS. 9 to 11 are typical diagrams, in the form of a wafer map, a situation of a defect of the inspected semiconductor wafer which is stored as the inspection result information database D3, respectively. A semiconductor wafer 21 shown in FIG. 9 has no defect, a semiconductor wafer 22 shown in FIG. 10 has three defects detected, and a semiconductor wafer 23 shown in FIG. 11 has six defects detected.

The steps S12A to S12C and the steps S13A to S13C are executed for the semiconductor wafer 21 shown in FIG. 9, respectively. All the usable area rates PUA-A to PUA-C thus obtained are 100%.

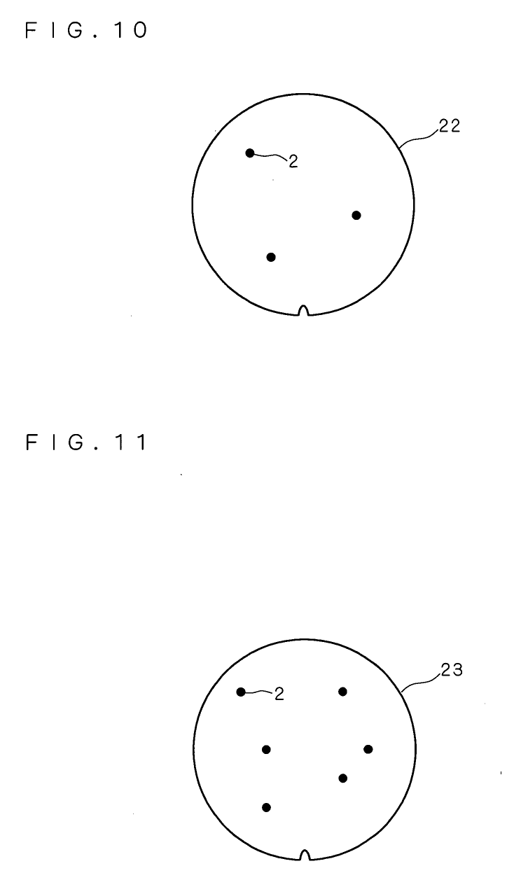

FIGS. 12 to 14 are typical diagrams showing contents of calculation of nonstandard cell numbers of the classes A to C for the semiconductor wafer 22 illustrated in FIG. 10, respectively.

As shown in FIG. 12, the virtual dividing unit cell 12A including any defect is determined to be a nonstandard cell 12Ad and the number (=3) of the nonstandard cells 12Ad is set to be a nonstandard cell number C0A. On the other hand, the virtual dividing unit cell 12A including no defect is determined to be a standard cell 12Ag and the number (=63) of the standard cells 12Ag is set to be a standard cell number C1A. Accordingly, a usable area rate PUA-A=(63/66)* 100=94.45% (rounded to two decimal places) is obtained.

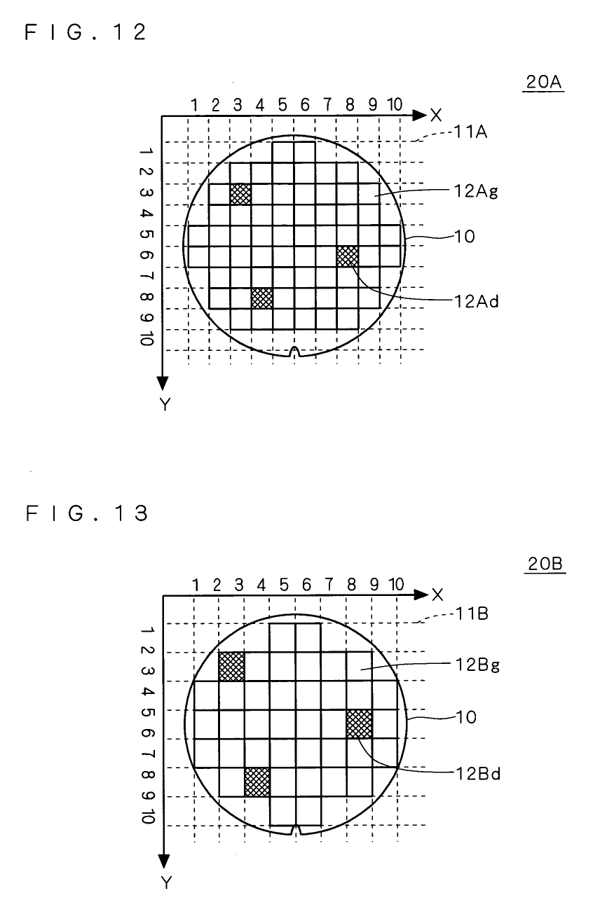

As shown in FIG. 13, the virtual dividing unit cell 12B including any defect is determined to be a nonstandard cell 12Bd and the number (=3) of the nonstandard cells 12Bd is set to be a nonstandard cell number C0B. On the other hand, the virtual dividing unit cell 12B including no defect is determined to be a standard cell 12Bg and the number (=37) of the standard cells 12Bg is set to be a standard cell number C1B. Accordingly, a usable area rate PUA-B=(37/40)* 100=92.5% is obtained.

As shown in FIG. 14, the virtual dividing unit cell 12C including any defect is determined to be a nonstandard cell 12Cd and the number (=3) of the nonstandard cells 12Cd is set to be a nonstandard cell number C0C. On the other hand, the virtual dividing unit cell 12C including no defect is determined to be a standard cell 12Cg and the number (=117) of the standard cells 12Cg is set to be a standard cell number C1C. Accordingly, a usable area rate PUA-C=(117/120)* 100=97.5 is obtained.

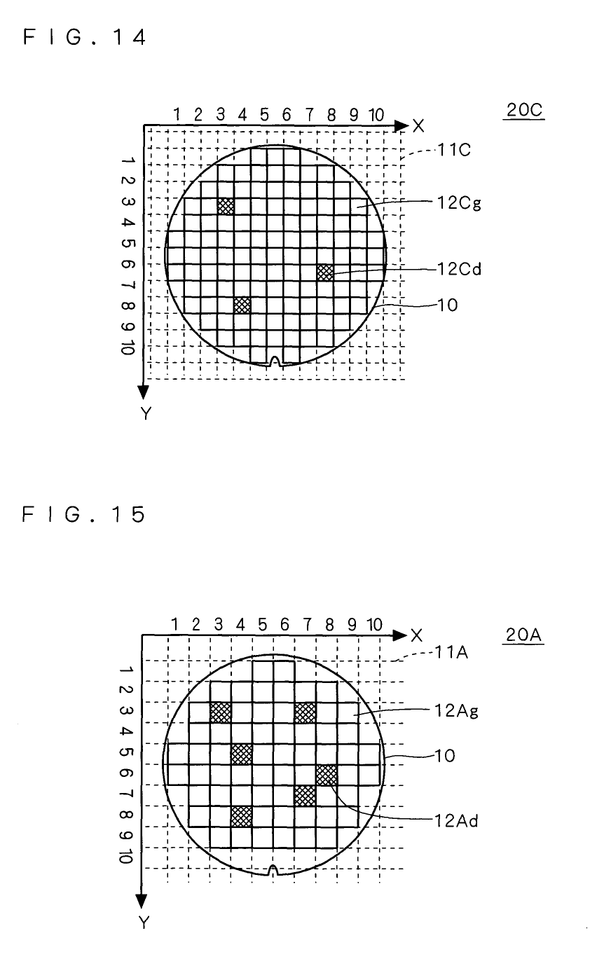

FIGS. 15 to 17 are typical diagrams showing contents of calculation of nonstandard portion containing virtual dividing cell numbers of the classes A to C for the semiconductor wafer 23 illustrated in FIG. 11, respectively.

As shown in FIG. 15, in the same manner as in FIG. 12, the nonstandard cell 12Ad and the standard cell 12Ag are determined, respectively. As a result, the nonstandard cell number C0A (=6) and the standard cell number C1A (=60) are obtained. Accordingly, a usable area rate PUA-A=(60/66)* 100=90.91% (rounded to two decimal places) is obtained.

As shown in FIG. 16, in the same manner as in FIG. 13, the nonstandard cell 12Bd and the standard cell 12Bg are determined, respectively. As a result, the nonstandard cell number C0B (=6) and the standard cell number C1B (=34) are obtained. Accordingly, a usable area rate PUA-B=(34/40)* 100=85.0% is obtained.

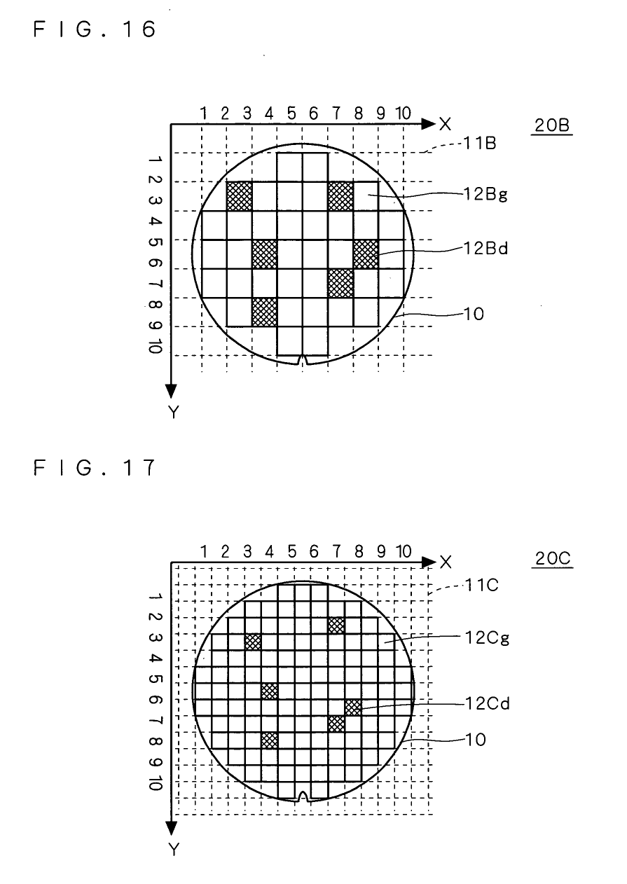

As shown in FIG. 17, in the same manner as in FIG. 14, the nonstandard cell 12Cd and the standard cell 12Cg are determined, respectively. As a result, the nonstandard cell number C0C (=6) and the standard cell number C1C (=114) are obtained. Accordingly, a usable area rate PUA-C=(114/120)* 100=95.0% is obtained.

Description will be given to an example of the processing of the step S14 to be executed after the usable area rates PUA-A to PUA-C are thus obtained in each of the three semiconductor wafers 21 to 23.

For example, in the case in which the usable area rate PUA to be a quality criterion of the classes A to C is 95% or more, a use can be determined (a synthetic quality decision can be carried out) in the following manner at the step S14.

In the class A, the semiconductor wafer 21 is decided to be excellent products and the semiconductor wafers 22 and 23 are decided to be a defective product. In the class B, only the semiconductor wafer 21 is decided to be the excellent product and the semiconductor wafers 22 and 23 are decided to be defective products. In the class C, all of the semiconductor wafers 21 to 23 are decided to be excellent products.

In the second embodiment, thus, the quality of the semiconductor wafer is decided for each of the classes A to C in addition to the effect of the first embodiment. Thus, it is possible to carry out the quality decision with high precision corresponding to the uses (the classes A to C).

For example, conventionally, the quality of the semiconductor wafer is usually inspected based on the strictest standard for the class B. Consequently, the semiconductor wafers 22 and 23 to be originally excellent products have been decided to be defective for the class C. In the present embodiment, however, the semiconductor wafers 22 and 23 can be decided to be the excellent product in the case of the use for the class C. Thus, it is possible to carry out the quality decision adapted to the class.

### Third Embodiment

In a third embodiment, “a thickness of an SOI layer of an SOI wafer” is employed for at least one inspection object item of inspections A to C to be stored in an inspection result information database D3, and the inspecting method according to the first or second embodiment is executed.

It is possible to obtain the thickness of the SOI layer by inspecting a distribution in a semiconductor wafer surface by means of a spectroreflectometer, a spectroellipsometry or the like. The spectroreflectometer measures 1500 points or more in a 200 mm φ wafer surface and can be sufficiently applied to the inspecting method according to the first or second embodiment.

In the third embodiment, thus, it is possible to carry out a quality decision with higher precision by employing “a thickness of an SOI layer of an SOI wafer” for an inspection object item. As a result, it is possible to effectively utilize a semiconductor wafer.

### Fourth Embodiment

In a fourth embodiment, “a thickness of a BOX layer (a buried insulating layer) of an SOI wafer” is employed for at least one inspection object item of inspections A to C to be stored in an inspection result information database D3, and the inspecting method according to the first or second embodiment is executed.

It is possible to obtain the thickness of the BOX layer by inspecting a distribution in a semiconductor wafer surface by means of a spectroreflectometer, a spectroellipsometry or the like. The spectroreflectometer measures 1500 points or more in a 200 mm φ wafer surface and can be sufficiently applied to the inspecting method according to the first or second embodiment.

In the fourth embodiment, thus, it is possible to carry out a quality decision with higher precision by employing “a thickness of a BOX layer of an SOI wafer” for an inspection object item. As a result, it is possible to effectively utilize a semiconductor wafer.

### Fifth Embodiment

In a fifth embodiment, “a loss of an SOI layer or both the SOI layer and a BOX layer” is employed for at least one inspection object item of inspections A to C to be stored in an inspection result information database D3, and the inspecting method according to the first or second embodiment is executed. “A loss of an SOI layer or both the SOI layer and a BOX layer” implies a defect in which the SOI layer of an SOI wafer is lost or a defect in which both the SOI layer and the BOX layer are lost.

The loss can become obvious by immersing the SOI wafer in hydrofluoric acid and circularly eluting the BOX layer and can be detected by an optical microscope observation. Moreover, a defect of an As—received wafer (a wafer which is not subjected to a manufacture processing at all) can also be detected as a particle having a size of 0.2 μm or more by a particle counter of a laser scattering type. Furthermore, it is also possible to detect the defect by an inspecting apparatus using a method of detecting a defect by an image comparison.

In the fifth embodiment, thus, it is possible to carry out a quality decision with higher precision by employing “a loss of an SOI layer or both the SOI layer and a BOX layer” for an inspection object item. As a result, it is possible to effectively utilize a semiconductor wafer.

### Sixth Embodiment

In a sixth embodiment, “a hillock defect of an epitaxial wafer” is employed for at least one inspection object item of inspections A to C to be stored in an inspection result information database D3, and the inspecting method according to the first or second embodiment is executed. “A hillock defect of an epitaxial wafer” implies a mound-shaped defect generated in the epitaxial wafer.

The hillock defect has an almost equal size to a thickness of an epitaxial layer and is a stacking fault or an abnormal growth portion which grows by setting, as a nucleus, a foreign substance or a defect of a semiconductor wafer which has not grown epitaxially. Accordingly, it is possible to detect the hillock defect as a particle having an almost equal size to the thickness of the epitaxial layer by means of a particle counter of a laser scattering type. Moreover, it is also possible to detect the hillock defect by means of an inspecting apparatus using a method of detecting a defect by an image comparison.

In the sixth embodiment, thus, it is possible to carry out a quality decision with higher precision by employing “a hillock defect of an epitaxial wafer” for an inspection object item. As a result, it is possible to effectively utilize a semiconductor wafer.

### Seventh Embodiment

In a seventh embodiment, “COP (Crystal Originated Particle)” is employed for at least one inspection object item of inspections A to C to be stored in an inspection result information database D3, and the inspecting method according to the first or second embodiment is executed.

The COP is known as a void having a size of approximately 0.1 μm in an Si crystal and is observed as a concave portion on a surface of a semiconductor wafer. Accordingly, it is possible to detect the COP by means of a particle counter of a laser scattering type which has the function of isolating a concave defect of the semiconductor wafer.

In the seventh embodiment, thus, it is possible to carry out a quality decision with higher precision by employing the “COP” for an inspection object item. As a result, it is possible to effectively utilize a semiconductor wafer.

FIG. 18 is an explanatory diagram listing, in the form of a table, the inspection object items according to the third to seventh embodiments. As shown in FIG. 18, the inspection object items having the above-mentioned contents are employed in order to carry out a quality decision with higher precision in each of the third to seventh embodiments.

### Eighth Embodiment

In an eighth embodiment, data to be equivalent to a device to be actually manufactured are given as dividing cell size data D1 and dividing cell arrangement data D2, and the inspecting method according to the first or second embodiment is executed.

FIG. 19 is an explanatory diagram showing a part of processing contents of an inspecting method according to the eighth embodiment of the present invention. As shown in FIG. 19, in the eighth embodiment, a virtual divided wafer is generated based on dividing cell size data D5 for a real device and dividing cell arrangement data D6 for the real device. The dividing cell size data D5 for the real device and the dividing cell arrangement data D6 for the real device define a cell size, an arrangement and the like which are equivalent to the device to be actually manufactured. Since other processings are the same as those of the first embodiment shown in FIG. 1 or the second embodiment shown in FIG. 5, description will be omitted.

In the eighth embodiment, thus, the virtual divided wafer is set based on the data corresponding to the real device. Consequently, it is possible to carry out a quality decision with high precision which is adapted to the real device. As a result, it is possible to effectively utilize a semiconductor wafer.

### Ninth Embodiment

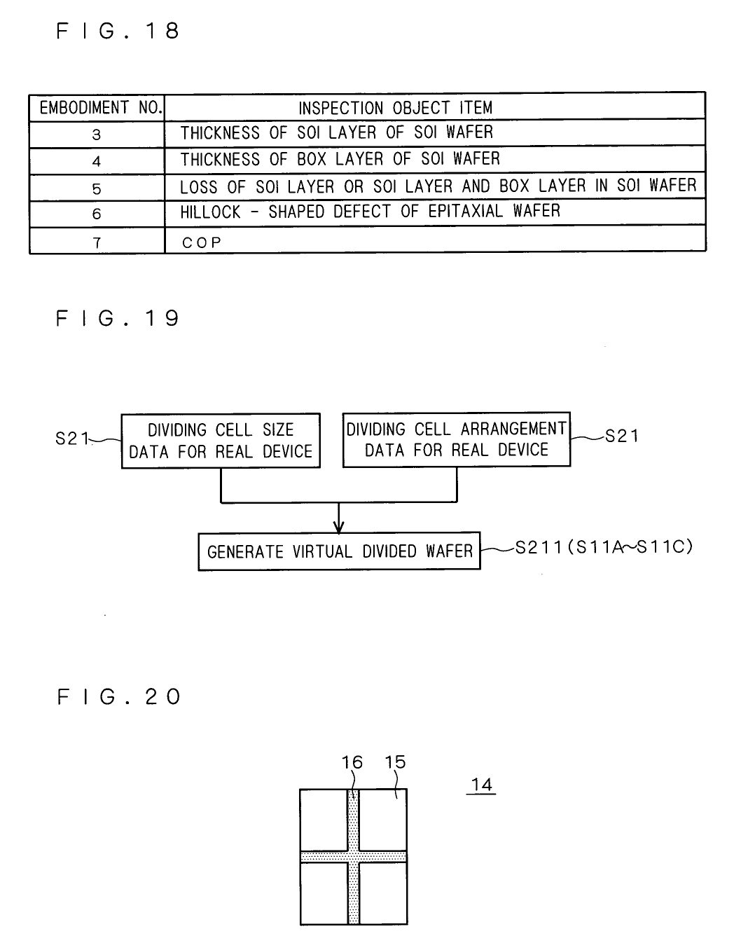

FIGS. 20 to 22 are explanatory views showing a memory cell area and a peripheral area in a one-chip memory device.

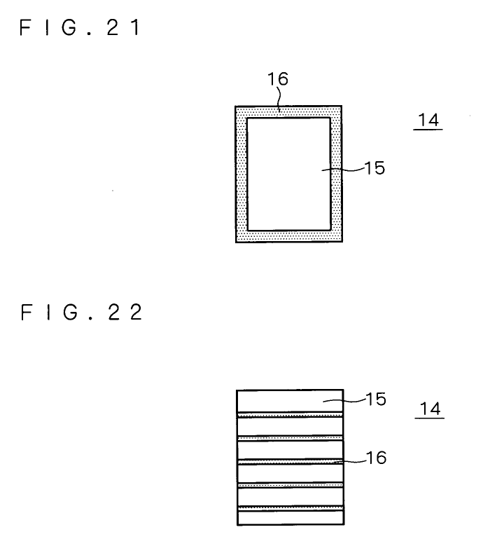

As shown in these drawings, the memory device is separated into the memory cell area and the peripheral area in one chip. In an example of FIG. 20, a cross-shaped peripheral area 16 is formed in a rectangular chip 14 and other areas are set to be a memory cell area 15. In an example of FIG. 21, the peripheral area 16 is formed to surround a periphery of the memory cell area 15 formed on a central part in the chip 14. In the chip 14 of FIG. 22, the memory cell area 15 and the peripheral area 16 are formed alternately.

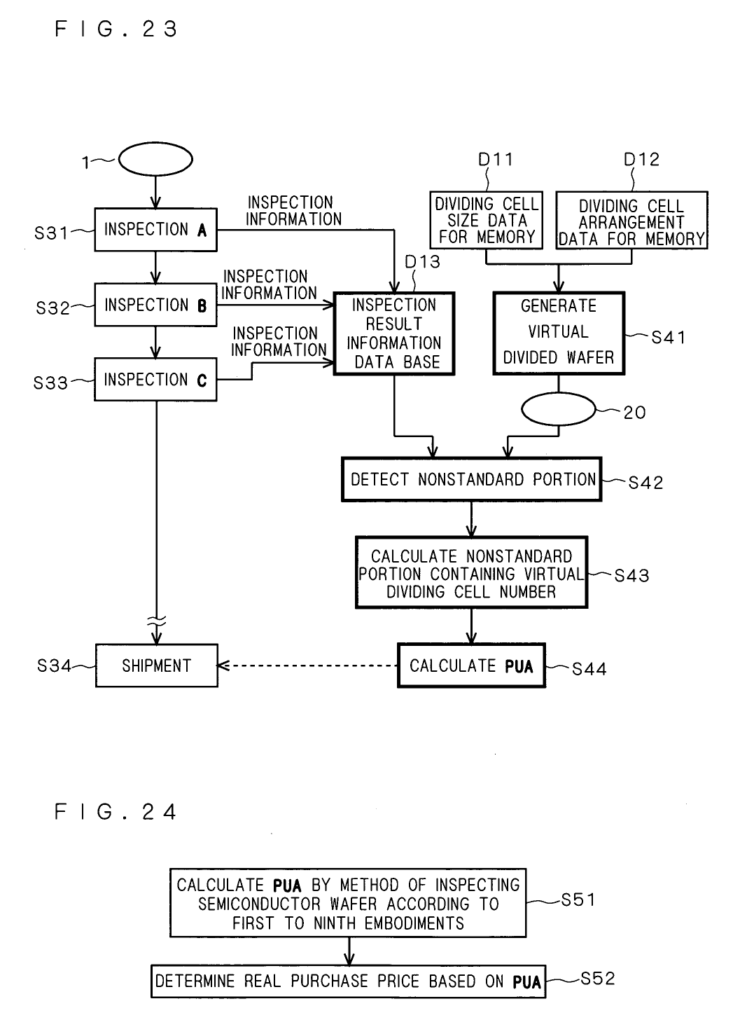

FIG. 23 is an explanatory diagram typically showing a processing procedure for a method of inspecting a semiconductor wafer according to a ninth embodiment together with a flow of data.

With reference to FIG. 23, at a step S31, an inspection is carried out based on an inspection A for a semiconductor wafer 1 and a whole inspection result is given to an inspection result information database D13 as inspection information.

At steps S32 and S33, then, an inspection is carried out based on inspections B and C for the semiconductor wafer 1 and results of the whole inspections B and C are given to the inspection result information database D13 as inspection information.

On the other hand, at a step S41, a virtual divided wafer 20M is generated by virtually dividing a virtual wafer through a virtual dividing unit cell based on dividing cell size data D11 defining a cell size, a shape and the like which are obtained by breaking down the virtual dividing unit cell to have a smaller size than a chip size and dividing cell arrangement data D12 defined such that each cell is independently separated and arranged in a memory cell area and a peripheral area. More specifically, a plurality of virtual dividing unit cells 12M for a memory cell and a plurality of virtual dividing unit cells 12P for a peripheral area are arranged on the virtual divided wafer 20M.

By the processing of the step S41, thus, a virtual dividing unit cell 12 is broken down to have a smaller size than the chip size. Consequently, the virtual divided wafer 20M is generated such that the virtual dividing unit cells 12M and 12P are independently present in the memory cell area and the peripheral area without overlapping, respectively.

At a step S42, then, a nonstandard portion is detected by checking the inspection result information database D13 over the virtual divided wafer 20M. More specifically, inspection information of the inspections A to C are verified based on standard values MR-A to MR-C of the inspections A to C for a memory cell with respect to the virtual dividing unit cell 12M for the memory cell respectively so that a nonstandard portion for the memory cell is detected. In addition, inspection information are verified based on standard values PR-A to PR-C for a peripheral area with respect to the virtual dividing unit cell 12P for the peripheral area so that a nonstandard portion is detected.

At a step S43, thereafter, the virtual dividing unit cell 12M for the memory cell is classified into a standard cell and a nonstandard cell for the memory cell based on the presence of the nonstandard portion for the memory cell so that a standard cell number C1M and a nonstandard cell number C0M for the memory cell are calculated, respectively. In addition, the virtual dividing unit cell 12P for the peripheral area is classified into a standard cell and a nonstandard cell for the peripheral area based on the presence of the nonstandard portion for the peripheral area so that a standard cell number C1P and a nonstandard cell number C0P for the peripheral area are calculated, respectively.

At the step S13 of FIG. 1, subsequently, a standard cell number C1 for a total virtual dividing unit cell number C10 is calculated. In this case, it is possible to propose the following two methods of calculating a usable area rate PUA.

\mathring{1} The usable area rate PUA is calculated for both the memory cell area and the peripheral area in the same manner as in the first and second embodiments. More specifically, PUA={(C1M+C1P)/(C10M+C10P)}·100 is calculated, wherein the total number of the virtual dividing unit cells 12M is represented by C10M and the total number of the virtual dividing unit cells 12P for the peripheral area is represented by C10P.

\mathring{2} A usable area rate PUA-M in the virtual dividing unit cell 12M for the memory cell and a usable area rate PUA-P in the virtual dividing unit cell 12P for the peripheral area are calculated separately. More specifically, {PUA-M=(C1M/C10M)·100} and {PUA-P=(C1P/C10P)* 100} are calculated.

At a step S34, then, a quality decision is carried out based on the usable area rate PUA obtained at a step S44 and a final shipment is thus decided. In this case, it is possible to set a price taking the influence of a nonstandard portion of a real device into account by setting the price based on the usable area rate PUA.

In the ninth embodiment, thus, the nonstandard portion is detected with different standard values in the memory cell area and the peripheral area also by the inspection having the same contents with respect to the semiconductor wafer for the memory device. Consequently, it is possible to carry out the quality decision with high precision which takes characteristics of the respective memory cell area and peripheral area into consideration.

In system on chip, moreover, various functional blocks are mixed on one chip. The functional blocks include a logic circuit portion such as a CPU, a storage portion such as a memory, a high frequency element portion, a passive element using an MEMS (Micro-Electro-Mechanical System) and the like. These can be collected into one chip to construct a multifunctional and high performance semiconductor device. For such system on chip, similarly, a standard value in each inspection object item is set to have different contents on a functional block unit such that the virtual dividing unit cell 12 is broken down (segmentized) and is independently present in each functional block in the same manner as in the memory device, and the same processings as those in the steps S31 to S33 and S41 to S44 are carried out.

As a result, it is possible to carry out a quality decision with high precision which takes a characteristic of each functional block into consideration with respect to a semiconductor wafer for the system on chip.

As a matter of course, it is possible to synthetically evaluate the inspecting method according to the ninth embodiment corresponding to a plurality of classes as in the second embodiment.

### Tenth Embodiment

FIG. 24 is a flow chart showing a method of determining a purchase price of a semiconductor wafer according to a tenth embodiment of the present invention.

With reference to FIG. 24, a usable area rate PUA for the quality decision processing according to the first to ninth embodiments is calculated at a step S51.

At a step S52, then, a real purchase price of a semiconductor wafer is determined based on the usable area rate PUA.

An example of the determination of the real purchase price at the step S52 will be described below in \mathring{1} to \mathring{4}.

\mathring{1} In the case of the usable area rate PUA=100%, a price is set to be a base price P1 and a real purchase price PS is determined by {PS=P1*(PUA/100)}.

\mathring{2} Only a semiconductor wafer having a usable area rate PUA to satisfy a preset reference rate is determined at a preset purchase price.

\mathring{3} In the case in which a ratio of the number of semiconductor wafers having the usable area rate PUA to satisfy the preset reference rate to all the semiconductor wafers is constant or more, all the semiconductor wafers are determined at the preset purchase price.

\mathring{4} n reference values REF1 to REFn (REF1>REF2> . . . >REFn) corresponding to the usable area rate PUA are set, and a price for PUA>REF1 is set to be PS1, a price for REF1>PUA≧REF2 is set to be PS2, and a price for REF(i−1)>PUA≧REFi (i=2 to n) is set to be PSi. PS1>PS2> . . . >PSn is set.

Thus, the method of determining a purchase price of a semiconductor wafer according to the tenth embodiment can determine a purchase price which accurately reflects the degree of excellence of the semiconductor wafer.

While the invention has been shown and described in detail, the foregoing description is in all aspects illustrative and not restrictive. It is therefore understood that numerous modifications and variations can be devised without departing from the scope of the invention.

What is claimed is:

1. A method of inspecting a semiconductor wafer comprising the steps of:
(a) carrying out an inspection including a predetermined inspection object item for a semiconductor wafer, thereby obtaining inspection information by which a position on said semiconductor wafer of a nonstandard portion satisfying no inspection standard can be recognized;
(b) virtually dividing a virtual wafer corresponding to said semiconductor wafer under a predetermined dividing condition, thereby generating a virtual divided wafer having a plurality of virtual dividing unit cells arranged virtually;
(c) checking said inspection information over said virtual divided wafer, thereby obtaining the number of standard cells which do not include said nonstandard portion in said virtual dividing unit cells; and
(d) calculating a usable cell rate to be a ratio of said number of said standard cells to the total number of said virtual dividing unit cells.

2. The method of inspecting a semiconductor wafer according to claim 1, wherein
said predetermined inspection object item includes plural kinds of inspection object items, and
said inspection information includes information of each of said plural kinds of inspection object items by which a position on said semiconductor wafer of said nonstandard portion can be recognized.

3. The method of inspecting a semiconductor wafer according to claim 1, wherein
said predetermined dividing condition includes plural kinds of dividing conditions,
said virtual divided wafer includes plural kinds of virtual divided wafers which are virtually divided under said plural kinds of dividing conditions,
said step (c) includes the step of checking said inspection information over each of said plural kinds of virtual divided wafers, thereby obtaining the number of said standard cells in each of said virtual divided wafers,
said step (d) includes the step of calculating said usable cell rate in each of said virtual divided wafers, and
the method of inspecting a semiconductor wafer further comprises the step of:
(e) synthetically deciding quality of said semiconductor wafer based on said usable cell rate in each of said virtual divided wafers.

4. The method of inspecting a semiconductor wafer according to claim 1, wherein
said semiconductor wafer includes an SOI wafer to be a wafer having an SOI structure, and
said predetermined inspection object item includes a thickness of an SOI layer of said SOI wafer.

5. The method of inspecting a semiconductor wafer according to claim 1, wherein
said semiconductor wafer includes an SOI wafer to be a wafer having an SOI structure, and
said predetermined inspection object item includes a thickness of a buried insulating layer of said SOI wafer.

6. The method of inspecting a semiconductor wafer according to claim 1, wherein
said semiconductor wafer includes an SOI wafer to be a wafer having an SOI structure, and
said predetermined inspection object item includes a loss of an SOI layer of said SOI wafer or losses of said SOI layer and a buried insulating layer.

7. The method of inspecting a semiconductor wafer according to claim 1, wherein
said semiconductor wafer includes an epitaxial wafer, and
said predetermined inspection object item includes a hillock-shaped defect of said epitaxial wafer.

8. The method of inspecting a semiconductor wafer according to claim 1, wherein
said predetermined inspection object item includes a COP (Crystal Originated Particle).

9. The method of inspecting a semiconductor wafer according to claim 1, wherein
said predetermined dividing condition includes a condition based on a shape and size of a real device to be actually formed on said semiconductor wafer.

10. The method of inspecting a semiconductor wafer according to claim 1, wherein
said virtual wafer includes first and second inspection object areas,
said virtual dividing unit cells include a plurality of first and second virtual dividing unit cells present in said first and second inspection object areas respectively,
said inspection standard includes first and second inspection standards which are different from each other,
said nonstandard portion includes first and second nonstandard portions,
said standard cell includes first and second standard cells,
said inspection information includes information capable of recognizing said first nonstandard portion which does not satisfy said first inspection standard for said first inspection object area and said second nonstandard portion which does not satisfy said second inspection standard for said second inspection object area, and
said step (c) includes the step of calculating the numbers of said first standard cells which do not include said first nonstandard portions in said first virtual dividing unit cells, and the number of said second standard cells which do not include said second nonstandard portions in said second virtual dividing unit cells.

11. The method of inspecting a semiconductor wafer according to claim 10, wherein
said first inspection object area includes a memory cell area, and
said second inspection object area includes a peripheral area.

12. The method of inspecting a semiconductor wafer according to claim 1, further comprising the step of:
(f) deciding a value of said semiconductor wafer based on said usable cell rate obtained at said step (d).
